(19) United States
(12) Patent Application Publication
(10) Pub. No.: US 2024/0386279 A1
(43) Pub. Date: Nov. 21, 2024

(54) METHOD AND SYSTEM FOR TRANSFER LEARNING FOR TIME-SERIES USING FUNCTIONAL DATA ANALYSIS

(71) Applicant: HITACHI, Ltd., Chiyoda-Ku (JP)

(72) Inventors: Aniruddha Rajendra RAO, San Jose, CA (US); Jana Cathrin BACKHUS, San Jose, CA (US); Ahmed FARAHAT, Santa Clara, CA (US); Chetan GUPTA, San Mateo, CA (US)

(21) Appl. No.: 18/199,498

(22) Filed: May 19, 2023

(51) Int. Cl. G06N 3/096

(52) U.S. Cl. CPC G06N 3/096

(57) ABSTRACT

Systems and methods described herein can involve learning a functional neural network (FNN) for a source domain associated with source time series data, the learning involving learning functional parameters of the FNN, the FNN comprising a plurality of layers of continuous neurons; transferring the functional parameters of the FNN to a target domain that is separate from the source domain; and tuning the functional parameters of the FNN with target time series data from the target domain, the target time series data having fewer samples than the source time series data.

### BACKGROUND

### Field

The present disclosure is generally directed to functional data analysis, and more specifically, for systems and methods for transfer learning for time-series using functional data analysis.

### Related Art

Time series analysis has gained a lot of interest in a wide variety of industrial sectors because of its importance. The exponentially growing volume of time series data can be used to get great insights into the business and make critical decisions at many companies. Generalization in time series is a relatively new topic. Generalization is very useful in cases where there is a huge amount of historical data for source items and limited historical data for target items.

Related art solutions for generalization are directed for multivariate data, which are inadequate for time series data. One approach would be to take the model (ARIMA, Linear regression (LR), Deep Neural Networks (DNN), Long short-term memory (LSTM), and so on) learned on source data and directly apply it to target data. This is limiting because the direct application cannot adapt to the nature of the target data, leading to poor results.

Functional data analysis (FDA) has proven to be a great statistical approach to analyzing time-series data with patterns. Functional models can be used to build mathematical mapping for time series data for different downstream tasks (like forecasting, prediction, classification, dimension reduction, and more). Compared to Deep Learning (DL), functional data modeling techniques use functional mapping to be more efficient in terms of capturing the rich information in time-series data (i.e., needing fewer parameters), less restrictive on data format (i.e., data can have different resolutions across samples), and less restrictive on the underlying mapping (i.e., the parameters can be different at different times within the considered time horizons). The advantage of FDA (more specifically Functional Neural Networks (FNN)) over DL has been shown in the related art. However, there is no generalization approach available in FDA. The approach of taking the model from the source and applying it to the target will again lead to poor results because they cannot adapt to the patterns in the target data.

### SUMMARY

Generalization in time series is a relatively new problem and is of significance. Such a generalization for time series will help solve many problems like predicting the energy demand for a newly instrumented city, forecasting the demand for a new product with limited history, predicting the electricity generation using new wind turbines, and so on. It can be very challenging for the time series model to generalize across different problems.

It is an object of the present disclosure to generalize the time series modeling task with the help of source domain information to a target domain, in which limited information is available. In this process, a Functional Neural Network (FNN) is first trained on source data, and the learned functional features (the network's functional weights) are then transferred to an FNN to be trained on a target data.

Example implementations described herein involve a novel approach for the generalization of the time series model using FNNs, that allows us to transfer the model to target items to perform the same modeling task (e.g., forecasting, classification, prediction).

FNNs are used as the pre-trained model learned from the source. The weights learned from the pre-trained model are used for the initialization of the target model; this model is then fine-tuned using a few samples from the target item. Example implementations described herein leverage FDA here to learn the underlying relationships in the FNN learned on the source and transfer that to the target model.

Aspects of the present disclosure can involve a method, which can include learning a functional neural network (FNN) for a source domain associated with source time series data, the learning comprising learning functional parameters of the FNN, the FNN involving a plurality of layers of continuous neurons; transferring the functional parameters of the FNN to a target domain that is separate from the source domain; and tuning the functional parameters of the FNN with target time series data from the target domain, the target time series data having fewer samples than the source time series data.

Aspects of the present disclosure can involve a computer program, storing instructions for executing a process, the computer program involving learning a functional neural network (FNN) for a source domain associated with source time series data, the learning comprising learning functional parameters of the FNN, the FNN comprising a plurality of layers of continuous neurons; transferring the functional parameters of the FNN to a target domain that is separate from the source domain; and tuning the functional parameters of the FNN with target time series data from the target domain, the target time series data having fewer samples than the source time series data. The computer program and instructions can be stored on a non-transitory computer readable medium and executed by one or more processors.

Aspects of the present disclosure can involve a system, which can include means for learning a functional neural network (FNN) for a source domain associated with source time series data, the learning comprising learning functional parameters of the FNN, the FNN involving a plurality of layers of continuous neurons; means for transferring the functional parameters of the FNN to a target domain that is separate from the source domain; and means for timing the functional parameters of the FNN with target time series data from the target domain, the target time series data having fewer samples than the source time series data.

Aspects of the present disclosure can involve an apparatus, which can involve a processor, configured to learn a functional neural network (FNN) for a source domain associated with source time series data, the learning comprising learning functional parameters of the FNN, the FNN comprising a plurality of layers of continuous neurons; transfer the functional parameters of the FNN to a target domain that is separate from the source domain; and tune the functional parameters of the FNN with target time series data from the target domain, the target time series data having fewer samples than the source time series data.

### BRIEF DESCRIPTION OF DRAWINGS

FIG. 1 is a flow diagram for the generalization approach, in accordance with an example implementation.

FIG. 2 is an illustration of the generalization idea for time series, in accordance with an example implementation.

FIG. 3 is the general architecture of Functional Neural Network (FNN), in accordance with an example implementation.

FIG. 4 illustrates a simulation example involving the example implementations described herein.

FIG. 5 illustrates an example comparison of different simulation settings across FLM and FNN using root mean square error (WAPE) on target data, in accordance with an example implementation.

FIG. 6 illustrates a system involving a plurality of physical systems networked to a management apparatus, in accordance with an example implementation.

FIG. 7 illustrates an example computing environment with an example computer device suitable for use in some example implementations.

### DETAILED DESCRIPTION OF THE INVENTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art of practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve a novel approach for the generalization of the time series model. The proposed system has the following aspects.

Data collection and storage: Historical data is collected and stored.

Model learning from source data: Historical data from the source is utilized to build a pre-trained model using FNN.

Model tuning to target data: The pre-trained model is utilized to fine-tune it to the target data using the weights of the pre-trained model as initial values of the parameters of the model for the target data.

Model deployment: This component deploys the learned model on streaming data to produce and transmit real-time data-driven information.

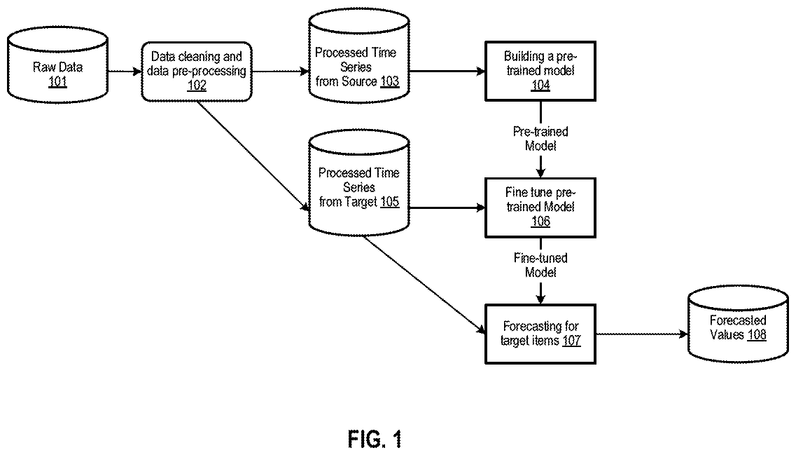

FIG. 1 is a flow diagram for the generalization approach for the time series data, in accordance with an example implementation. The proposed data-driven approach involves the following aspects.

Data checking and data pre-processing module 102 intakes raw data 101 and aims to ensure that the time series data to be used in the later calculation is regularly observed over time (i.e., without big time gaps between adjacent observations). Further, the data checking and data pre-processing module 102 checks for outliers and remove them, if any.

Building a pre-trained source model 104 from processed time series from the source 103, which conducts the learning phase for developing the pre-trained model from FNN using the historical data from the source 103.

Fine-tuning pre-trained source model 106 from processed time series from the target 105, which conducts the fine-tuning phase using pre-trained model weights as the initial values of the parameters of the model for the limited target data.

Forecasting for target items 107 from applying the generalized fine-tuned model to generate forecasted values 108. In this aspect, the applying phase of the learned generalization model is conducted from the fine-tuned model.

With regards to the data checking and data pre-processing 102, there are a few steps involved in this module that are conducted before the data is used as an input to these Machine Learning (ML) and Deep Learning (DL) algorithms. These relevant data preparation steps are performed on the input data before it is pushed into these algorithms. The present disclosure is not restricted to any specific data preparation method.

Examples of data checking and data pre-processing steps can involve, but are not limited to, Noise/outlier removal, Missing data imputation, and so on. Once data is prepared, it is further divided into training and testing sets. The training set is used during the model training phase, while the testing set is used for evaluating the model.

With regards to building a pre-trained source model 104, some mathematical notations are used as follows. Suppose that the number of samples is N. For each of the samples, the time series data is observed within time range T. Let the observed data be defined using X_{i,j}(t_{i,j}), with t_{i,j}∈T for j=1, . . . , M, i=1, . . . , N. The modeling tasks can be forecasting, prediction or classification.

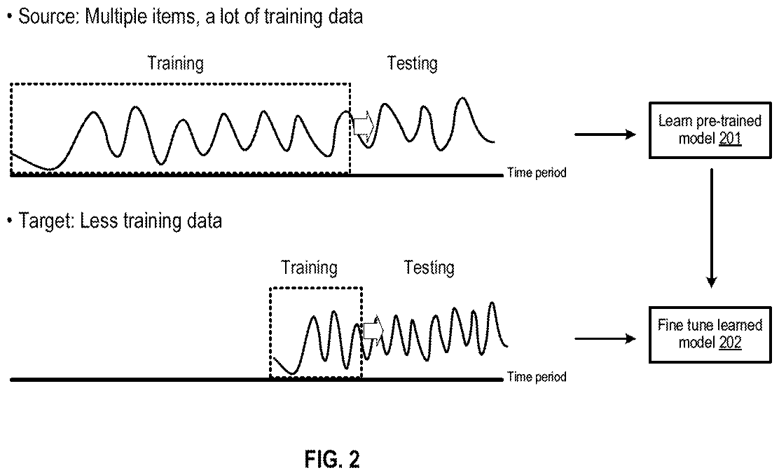

FIG. 2 is an illustration of the generalization idea for time series, in accordance with an example implementation. Example implementations described herein first learn the FNN model using the data from the source domain. This is known as the pre-trained model 201. The weights that are used are learned from this pre-trained model for the initialization of the target model; this model is then fine-tuned 202 using the available samples from the target item.

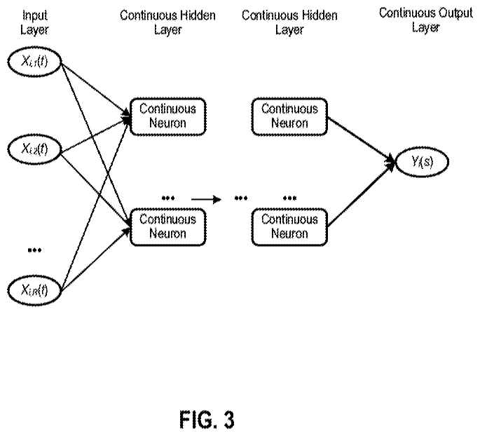

For the pre-trained model 201, the data from the source is used and fed into the Functional Neural Network (FNN) to get the output. FNN identifies the underlying patterns in the data to optimize the model. It takes advantage of the Neural Network architecture as seen in FIG. 3 to find complex relations in these patterns.

FIG. 3 is the general architecture of Functional Neural Network (FNN), in accordance with an example implementation. A Functional Neural Network involves continuous neurons which make up the continuous hidden layers. The l^{th} continuous hidden layer and k^{th} continuous neuron is defined as follows, H₍ₖ₎^{(l)}(s)=σ(b₍ₖ₎^{(l)}(s)+Σⱼ₌₁^{J}∫w_{(j,k)}^{(l)}(s, t) H₍ⱼ₎^{(l-1)}(t)dt) where σ is the activation function, b₍ₖ₎^{(l)}(s) is the parameter function and w_{(j,k)}^{(l)}(s, t) is the bivariate parameter function. Using the defined continuous neurons, the forward propagation can be completed and the partial derivatives are computed to update the parameter functions in the back-propagation step. The forward and backward propagation are repeated until a stopping criterion is reached. FNN also has the flexibility to consider other functional features that enable us to improve upon the current results. In example implementations described herein, the number of continuous hidden layers, the number of continuous neurons in each of the continuous hidden layers, and the activation functions can all be customized and set in accordance with the desired implementation.

With regards to the fine-tuning of the pre-trained source model 106 from processed time series from the target 105, example implementations learn a model on the target data which has limited historical information. The pre-trained model from 104 is fine-tuned at 106 to the target from the target data 105. The functional information captured in the pre-trained FNN is used and transferred to the target model. This process is done by taking the weights of the pre-trained (FNN) model and using it as the initial weight for the FNN model that we plan to learn on a few target samples. Once we do this initialization of the weights, we go back and forth between the forward and backward propagation till a stopping criterion is reached on this target data.

With regards to forecasting for target items 107 from applying the fine-tuned model to generate forecasted values 108, the learned model for the target time series data is used to get the output for the target data for different analytical tasks.

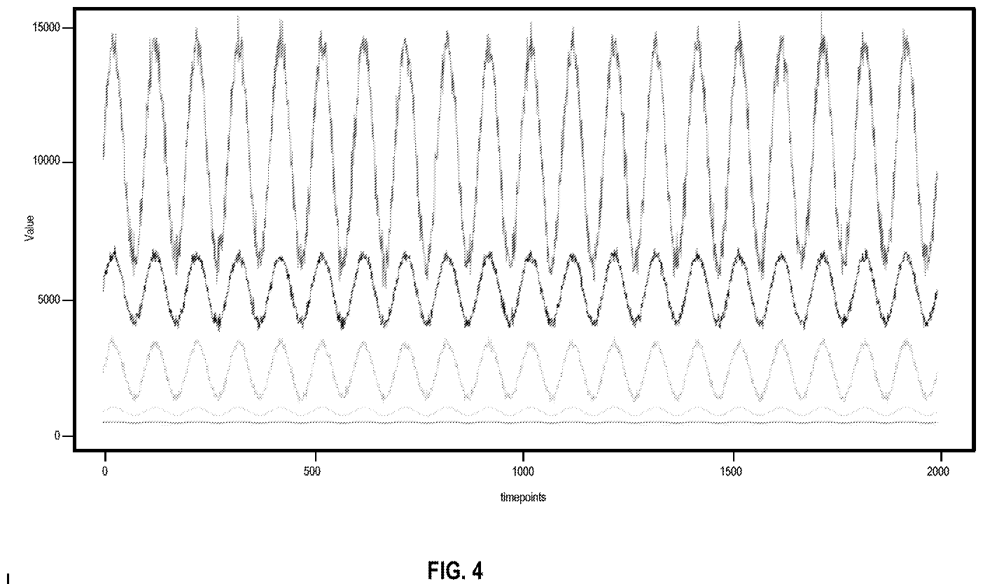

FIG. 4 illustrates a simulation example involving the example implementations described herein. In the example of FIG. 4, six Sin functions (with noise+10 and *multipliers) were measured over 2000 timepoints with different magnitudes, with a cyclic pattern every 100 timepoints. One of the Sin function is considered to be a target whereas the other fice are used to build the pre-trained model. The first 1600 time points were used for training, and the remaining 400 time points were used for testing. Four experiments were conducted. In the first experiment, the window size is 100 time points, in the second experiment, the window size is 40 time points, in the third experiment, the window size is 25 time points, and in the fourth experiment, the window size is 10 time points.

In the example implementations described herein, frame window sizes are selectable in which the frame window is used to forecast the next frame window. For example, if there is a window size of 100, it means that the first 100 values are used to forecast the next 100 values and so on, and multiple samples are used across the available timepoints. Accordingly, for a window size of 100, the first training sample is timepoints 1 to 100 to forecast for timepoints 101 to 200. The second window is 101 to 200 which is used to forecast the timepoints of 201 to 300. In this manner, for the 1600 timepoints, 15 training samples can be used. As the cyclic pattern is unknown, any window size can be used freely to ensure robustness.

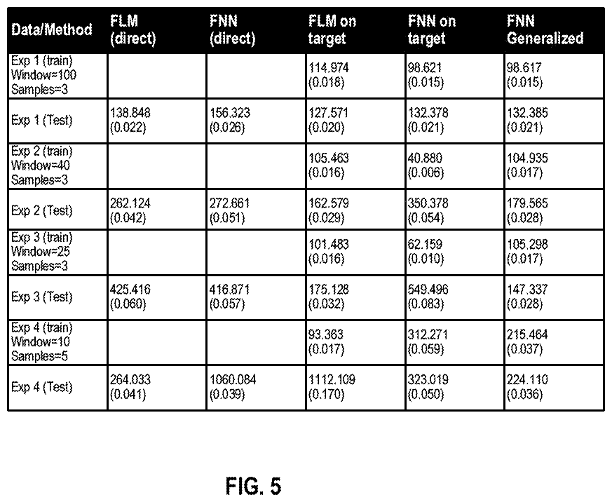

FIG. 5 illustrates an example comparison of different simulation settings across FLM and FNN using RMSE on the target data, in accordance with an example implementation. In this example, learning is conducted in the target domain. In the target data for the indicated experiments, because the target domain has limited data, there are only three samples for training. The first two columns involve the related art implementations of using the pre-trained FLM and FNN directly on the target data without any fine tuning. Because the FLM and FNN pre-trained models are directly applied, there is no training or fine tuning, which results in the RMSE scores as indicated. In the next two columns, FLM and FNN are trained directly on the target samples despite the limited sample size, which results in the indicated RMSE scores. The last column is in accordance with the example implementations in which the FNN pre-trained model is turned on the samples to transfer the source domain to the target domain, which results in the RMSE scores indicated in the last column. As shown in the table, the proposed example implementations generally outperform the other related art techniques. Should more samples be available, the quality of the fine-tuned model will further increase wherein the error values will decrease accordingly.

Compared to the related art, the example implementations described herein involving the proposed generalization times series approach have the following advantages. Example implementations can leverage FDA to do better transfer learning for time series data. Example implementations enable capturing complex mapping with the help of FNN. The example implementations are further able to generalize to target data with limited history. The example implementations are also able to model different tasks like forecasting, classification, and prediction.

In particular, the proposed forecasting approach is valuable in the following scenarios, such as any industry in which time series information is available, or if a product is launched and a model is needed to forecast various aspects of the product.

Further, the example implementations can be useful for any situation where generalization/transfer learning of time series or functions is needed. Examples of these are demand forecasts in multiple industrial areas, weather predictions across cities, and so on.

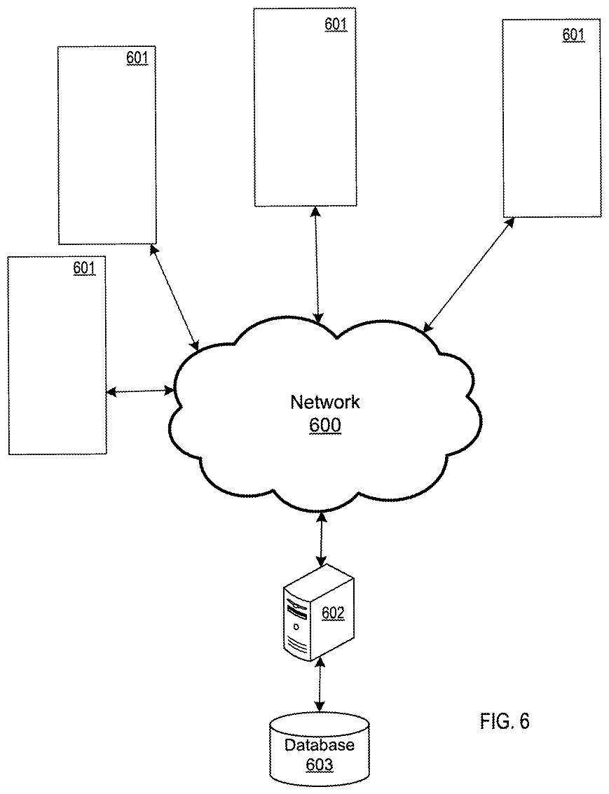

FIG. 6 illustrates a system involving a plurality of physical systems networked to a management apparatus, in accordance with an example implementation. One or more physical systems 601 integrated with various sensors are communicatively coupled to a network 600 (e.g., local area network (LAN), wide area network (WAN)) through the corresponding network interface of the sensor system installed in the physical systems 601, which is connected to a management apparatus 602. The management apparatus 602 manages a database 603, which contains historical data collected from the sensor systems from each of the physical systems 601. In alternate example implementations, the data from the sensor systems of the physical systems 601 can be stored in a central repository or central database such as proprietary databases that intake data from the physical systems 601, or systems such as enterprise resource planning systems, and the management apparatus 602 can access or retrieve the data from the central repository or central database. The sensor systems of the physical systems 601 can include any type of sensors to facilitate the desired implementation, such as but not limited to gyroscopes, accelerometers, global positioning satellite (GPS), thermometers, humidity gauges, or any sensors that can measure one or more of temperature, humidity, gas levels (e.g., CO2 gas), and so on. Examples of physical systems can include, but are not limited to, shipping containers, lathes, air compressors, and any other device that can be networked as an Internet of Things (IoT) device and/or controlled remotely by the management apparatus 602 as needed. Further, the physical systems can also be represented as virtual systems, such as in the form of a digital twin.

In example implementations described herein, the management apparatus 602 may deploy one or more machine learning models. Such dimension reduced form can be used by machine learning models in the management apparatus 602 or transmitted to an external system for analysis. Depending on the analysis from such machine learning models, management apparatus 602 may control one or more physical systems 601 accordingly. For example, if the analysis indicates that one of the physical systems 601 needs to be shut down or reoriented, management apparatus 602 may control such a physical system to be shut down, reconfigured, or reoriented in accordance with the desired implementation.

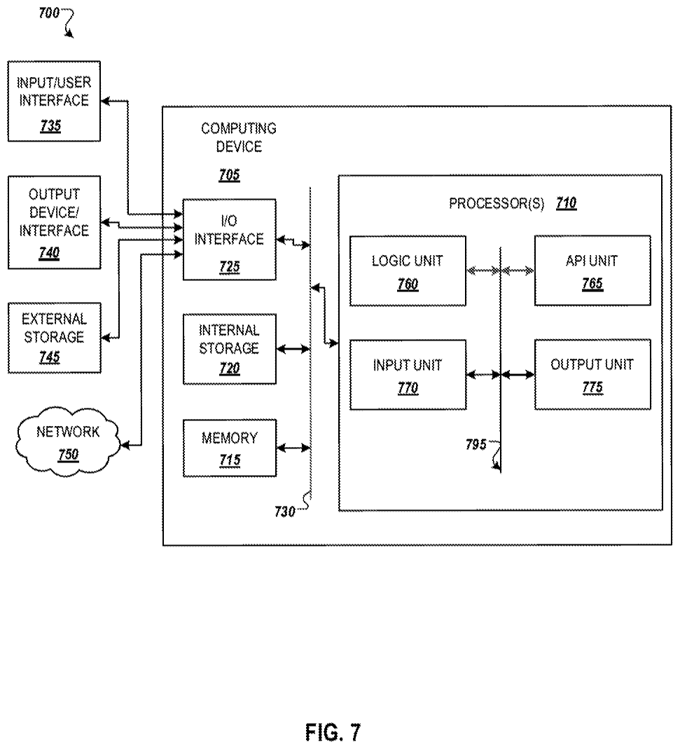

FIG. 7 illustrates an example computing environment with an example computer device suitable for use in some example implementations, such as a management apparatus 602 as illustrated in FIG. 6. Computer device 705 in computing environment 700 can include one or more processing units, cores, or processors 710, memory 715 (e.g., RAM, ROM, and/or the like), internal storage 720 (e.g., magnetic, optical, solid state storage, and/or organic), and/or I/O interface 725, any of which can be coupled on a communication mechanism or bus 730 for communicating information or embedded in the computer device 705. I/O interface 725 is also configured to receive images from cameras or provide images to projectors or displays, depending on the desired implementation.

Computer device 705 can be communicatively coupled to input/user interface 735 and output device/interface 740. Either one or both input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computer device 705. In other example implementations, other computer devices may function as or provide the functions of input/user interface 735 and output device/interface 740 for a computer device 705.

Examples of computer device 705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 705 can be communicatively coupled (e.g., via I/O interface 725) to external storage 745 and network 750 for communicating with any number of networked components, devices, and systems, including one or more computer devices of the same or different configurations. Computer device 705 or any connected computer device can be functioning as, providing services of or referred to as a server, client, thin server, general machine, special-purpose machine, or another label.

I/O interface 725 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computer device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system (OS)(not shown), in a native or virtual environment. One or more applications can be deployed that include logic unit 760, application programming interface (API) unit 765, input unit 770, output unit 775, and inter-unit communication mechanism 795 for the different units to communicate with each other, with the OS, and with other applications (not shown). The described units and elements can be varied in design, function, configuration, or implementation and are not limited to the descriptions provided. Processor(s)710 can be in the form of hardware processors such as central processing units (CPUs) or in a combination of hardware and software units.

In some example implementations, when information or an execution instruction is received by API unit 765, it may be communicated to one or more other units (e.g., logic unit 760, input unit 770, output unit 775). In some instances, logic unit 760 may be configured to control the information flow among the units and direct the services provided by API unit 765, input unit 770, output unit 775, in some example implementations described above. For example, the flow of one or more processes or implementations may be controlled by logic unit 760 alone or in conjunction with API unit 765. The input unit 770 may be configured to obtain input for the calculations described in the example implementations, and the output unit 775 may be configured to provide output based on the calculations described in the example implementations.

Processor(s) 710 can be configured to execute a method or instructions which can involve learning a functional neural network (FNN) for a source domain associated with source time series data (103, 104), the learning involving learning functional parameters of the FNN, the FNN involving a plurality of layers of continuous neurons (FIG. 3); transferring the functional parameters of the FNN to a target domain that is separate from the source domain (106); and tuning the functional parameters of the FNN with target time series data from the target domain (105, 106), the target time series data having fewer samples than the source time series data. Through such an example implementation, even if there are insufficient samples to train a new model for the target domain, the pre-trained model can be tuned to apply to the target domain based on the available samples in a manner that has fewer errors than attempting to apply the pre-trained model to the target domain directly or training a model from insufficient samples as illustrated in FIG. 5.

Processor(s) 710 can be configured to execute a method or instructions as described above, and further involve generating forecasts, predictions, and classifications for the time domain by executing the FNN on additional target time series data received from the time domain (107, 108). In example implementations, such forecasts, predictions, and classifications can be used to control physical systems as described in FIG. 6.

Processor(s) 710 can be configured to execute a method or instructions as described above, and further, involve receiving a window size input for learning the FNN; wherein the learning of the FNN is conducted using the window size input for the source time series data; and wherein the turning the FNN is conducted using the window size input on the target time series data as illustrated in FIGS. 1, 2, and 4. Through this manner, robustness can be ensured even if the cyclic pattern is not known. The receiving of a window size input can be conducted through any technique known in the art, such as through a user interface.

In example implementations, the target time series data can involve insufficient samples to learn a linear regression-based model or a deep learning model as illustrated in FIGS. 4 and 5. Linear regression-based models and deep learning models require sufficient sample sizes in order to procure a model, however, such data may not be available especially if the target domain is new. Through the example implementations described herein, even if there are insufficient samples to learn a linear regression-based model or a deep learning model, a robust FNN model can still be trained and learned.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
learning a functional neural network (FNN) for a source domain associated with source time series data, the learning comprising learning functional parameters of the FNN, the FNN comprising a plurality of layers of continuous neurons;
transferring the functional parameters of the FNN to a target domain that is separate from the source domain; and
tuning the functional parameters of the FNN with target time series data from the target domain, the target time series data having fewer samples than the source time series data.

2. The method of claim 1, further comprising generating forecasts, predictions, and classifications for the target domain by executing the FNN on additional target time series data received from the target domain.

3. The method of claim 1, further comprising:
receiving a window size input for learning the FNN; and
wherein the learning of the FNN is conducted using the window size input for the source time series data;
wherein the tuning of the functional parameters of the FNN is conducted using the window size input on the target time series data.

4. The method of claim 1, wherein the target time series data comprises insufficient samples to learn a linear regression-based model or a deep learning model.

5. A non-transitory computer readable medium, storing instructions for executing a process, the instructions comprising:
learning a functional neural network (FNN) for a source domain associated with source time series data, the learning comprising learning functional parameters of the FNN, the FNN comprising a plurality of layers of continuous neurons;
transferring the functional parameters of the FNN to a target domain that is separate from the source domain; and
tuning the functional parameters of the FNN with target time series data from the target domain, the target time series data having fewer samples than the source time series data.

6. The non-transitory computer readable medium of claim 5, the instructions further comprising generating forecasts, predictions, and classifications for the target domain by executing the FNN on additional target time series data received from the target domain.

7. The non-transitory computer readable medium of claim 5, the instructions further comprising:
receiving a window size input for learning the FNN; and
wherein the learning of the FNN is conducted using the window size input for the source time series data;
wherein the tuning of the functional parameters of the FNN is conducted using the window size input on the target time series data.

8. The non-transitory computer readable medium of claim 5, the instructions wherein the target time series data comprises insufficient sample to learn a linear regression-based model or a deep learning model.

9. An apparatus, comprising:
a processor, configured to:
learn a functional neural network (FNN) for a source domain associated with source time series data, the learning comprising learning functional parameters of the FNN, the FNN comprising a plurality of layers of continuous neurons;
transfer the functional parameters of the FNN to a target domain that is separate from the source domain; and
tune the functional parameters of the FNN with target time series data from the target domain, the target time series data having fewer samples than the source time series data.

10. The apparatus of claim 9, wherein the processor is configured to generate forecasts, predictions, and classifications for the time domain by executing the FNN on additional target time series data received from the time domain.

11. The apparatus of claim 9, wherein the processor is configured to:
receive a window size input for learning the FNN; and
wherein the processor is configured to learn the FNN is conducted using the window size input for the source time series data;
wherein the processor is configured to tune the FNN is conducted using the window size input on the target time series data.

12. The apparatus of claim 9, wherein the target time series data comprises insufficient samples to learn a linear regression-based model or a deep learning model.
